(19) United States
(12) Patent Application Publication
(10) Pub. No.: US 2014/0207367 A1
(43) Pub. Date: Jul. 24, 2014

(54) METHOD FOR DEFINING A FALL BACK ROUTE FOR A MOBILE MACHINE, METHOD OF FALL BACK, BY A MOBILE MACHINE, FOR SUCH A ROUTE, ASSOCIATED MODULES AND COMPUTER PROGRAMMES

(71) Applicant: DASSAULT AVIATION, Paris (FR)

(72) Inventors: Jean-Michel PFLIMLIN, Triel Sur Seine (FR); Gildas DAUPHIN, Marly-Le-Roi (FR)

(73) Assignee: DASSAULT AVIATION, Paris (FR)

(21) Appl. No.: 14/154,063

(22) Filed: Jan. 13, 2014

(30) Foreign Application Priority Data
Jan. 18, 2013 (FR) 13 00111

(51) Int. Cl. G01C 21/00

(52) U.S. Cl. CPC G01C 21/00
USPC 701/400

(57) ABSTRACT

A Method for defining a fall back route comprising of way points, for a mobile machine, in a 3D zone (ZNd) of displacement having convex zones (Zni, i=1 to 7) each describing a polygon in any plane perpendicular to a Z axis over a considered region (Hj, j=1 to 6) of a Z axis, according to which: set of beacons points (PBk, k=1 to 7) is defined, such that the edges of the Voronoi diagram associated with the said set of beacon points separate therebetween the polygons described by the convex zones in a plane perpendicular to the Z axis over the said region.

### CROSS-REFERENCE TO RELATED APPLICATIONS

This application claims benefit of French patent application number FR13 00111, filed Jan. 18, 2013, which is herein incorporated by reference.

### BACKGROUND OF THE INVENTION

1. Field of the Invention

The present invention relates to a method for defining a fall back route comprising of way points, for a mobile machine, in a 3D zone of displacement having convex zones such that over a considered region of a Z axis, the said zones each describe a polygon in any plane perpendicular to a Z axis.

For example, when the mobile machine is an aircraft, in nominal flight conditions, an operator monitors that the flight plan followed by the air craft whether manned or unmanned, is indeed consistent with and within the zone of displacement that has been assigned to it. However, in the event of contingencies (technical damage, loss of communication, or operator control), the aircraft may have to depart from its current flight plan in order to reach a predetermined fall back route, referred to as an emergency route, defined by a series of way points, which is supposed to return it to the base or any other safe and secure site (a parking hippodrome for example). Reaching this emergency route should above all not lead the air craft to departing from the zone of displacement that has been assigned to it.

Indeed, the event of “exiting the zone” is considered potentially catastrophic. In some cases, the severity of the event can be even greater than the loss of the aircraft.

The zone of displacement, generally connected and not convex, is subdivided into a plurality of convex zones each defined on a given altitude band.

Such a convex zone is generally constituted by a parallelepiped such that its projection on any whichever horizontal plane of the given altitude band, gives a same convex polygon in the horizontal plane.

2. Description of the Related Art

The assembling of these convex zones can lead to a very complex displacement zone geometry.

For example, FIG. 1 shows a displacement zone ZNd comprising of seven convex zones ZN1, ZN2, ZN3, ZN4, ZN5, ZN6 and ZN7. The zone ZNd is not convex. But it is connected in that there is at least one path which enables the joining of any two points of the zone ZNd while remaining within the zone ZNd.

For a non-holonomic machine unit, it is a known technique to calculate the routes which remain contained in the same convex zone, as long as the points of departure and arrival, as well as turning circles around these two points are in the same convex zone (using Dubin curves for example).

The problem to be resolved, during an event related to reaching an emergency route, is thus to determine, among all of the way points of the emergency route, which ones are in the same convex zone as the mobile machine at the moment of initiating the fall back, in a manner so as to reach the emergency route by first reaching one of these way points in the emergency zone, and then following the emergency route, and thus not exiting the assigned zone of displacement.

Given that it is considered a point in the space representing the position of the mobile machine and a set of convex zones, the currently existing solutions propose to test, for each convex zone, whether the considered point belongs within that zone.

With the mobile machine storing the set of vertices for each convex zone in an orderly manner (for example in the clockwise direction), simple criteria are used to verify whether the considered point belongs within this convex zone, by checking for example that the sum of the angles linking the point to each of the vertices of the convex zone, taking the axis between the point and a first vertex of the convex zone as a reference, is equal to 360°.

The problem with currently existing solutions is that they impose a requirement to store all the coordinates of the vertices of all of the convex zones and to perform calculations with respect to all the points stored, which necessitates a large data storage volume in an ongoing manner, and which, during events involving the fall back to an emergency route, engenders great complexity and a large volume of calculations requiring the engagement of powerful computing machines.

It is thus desirable to determine a solution limiting the complexity of the algorithms that are designed to help reach an emergency route and/or limit the volume of data to be stored.

### SUMMARY OF THE INVENTION

To achieve this end, according to a first aspect, the invention provides a method for defining a fall back route of the aforementioned type characterised in that it comprises the following steps i/ to ii/ relative to the said region of the Z axis, in considering any plane perpendicular to the Z axis over said region:

i/ defining a set of points, referred to as beacons points for the fall back route, such that the edges of the Voronoi diagram associated with said set of beacon points separate therebetween the polygons described by the convex zones in said plane; and

ii/ in a database, associating with each way point of the fall back route and each beacon point of the route, an identifier of the convex zone to which said point belongs, coordinates of said point and for each beacon point, an identifier of the said region of the Z axis.

Such a definition of the emergency route allows a mobile machine to bypass the knowledge of the shape of the zone of displacement and to take into account only the information pertaining to the emergency route thus defined and engaged, in order to determine from amongst the way points of the emergency route, which are the ones that are in the same convex zone as the mobile machine at the time of initiating the fall back to the emergency route. Thus the mobile machine will not need to store the coordinates of the convex zones.

By having knowledge solely about its position at the time of initiating the fall back to the emergency route and data related to the definition of the emergency route, the mobile device will be able to determine in an autonomous fashion, from amongst the way points of the emergency route, which are the ones that are in the same convex zone as the mobile machine at the time of reaching the emergency route, without knowledge a priori of the convex zone in which it is located.

In the embodiments, the method for defining a fall back route according to the invention further includes one or more of the following characteristic features:

the way points of the fall back route include at least some of the said beacon points in the said region under consideration of the Z axis;

the Z-axis is cut into a plurality of regions, such that the polygons described by the convex zones of the zone of displacement are constant in all planes perpendicular to the Z axis over a same region;

in each region, the steps it and ii/ are carried out; and

in step i/, a new beacon point is inserted in a polygon described in a convex zone, and moreover there is a further addition of every additional beacon point that is symmetrical with said new beacon point relative to any side of said polygon and which is located in another polygon, described by another convex zone over the said region of the Z axis.

According to a second aspect, the present invention provides a module for defining a fall back route comprising of way points, for a mobile machine, in a 3D zone of displacement having convex zones such that over a considered region of a Z axis, said zones each describing a polygon in any plane perpendicular to a Z axis, said module being characterised in that it is adapted to, relative to said region of the Z axis and taking into consideration any plane perpendicular to the Z axis over said region, define a set of points, referred to as beacon points, for the fall back route, such that the edges of the Voronoi diagram associated with said set of beacon points separate therebetween the polygons described by convex zones in said plane; and

in that it is adapted so as to, in a database, associate with each way point of the fall back route and each beacon point of the route, an identifier of the convex zone to which the said point belongs, the coordinates of said point and for each beacon point, an identifier of the said region of the Z axis.

According to a third aspect, the present invention proposes a computer programme for the definition of a fall back route comprising of way points, for a mobile machine, in a 3D zone of displacement having convex zones such that over a considered region (Hj, j=1 to 6) of a Z axis, said zones each describe a polygon in any plane perpendicular to a Z axis, said programme including instructions for carrying out the steps of a method according to the first aspect of the invention during the execution of the programme by the data processing means.

According to a fourth aspect, the present invention provides a method of fall back, by a mobile machine, to a fall back route, in a 3D zone of displacement of the mobile machine having convex zones each describing a polygon in any plane perpendicular to a Z axis in a region under consideration of the Z axis, said method being characterised in that the mobile machine stores an on board database of way points and beacon points of a fall back route that has been previously defined by a method according to the first aspect of the invention, and in that said method comprises of the following steps of:

determination of the value on the Z axis corresponding to the current position of the mobile machine and determination, from among the beacon points of the fall back route in the on board database, of the beacon points associated with an identifier of the region of the Z axis such that the value on the Z axis determined for the mobile machine is comprised within said region;

identification, from among said beacon points determined, of the beacon point that is closest to the mobile machine, on the basis of the coordinates of the beacon points in the database and taking into consideration that the determined beacon points are at the same level on the Z axis as the mobile machine; and

selection of a way point to be reached by the mobile machine from among the way points, in the database, which are associated with the same convex zone identifier as the convex zone identifier associated with the beacon point identified.

According to a fifth aspect, the present invention provides a module for determination for a mobile machine, of a fall back route, in a 3D zone of displacement of the mobile machine comprising convex zones each describing a polygon in any plane perpendicular to a Z axis over a region under consideration of the Z axis, the mobile machine storing an on board database of way points and beacon points of a fall back route that has previously been defined by a method according to the first aspect of the invention;

said determination module being designed to determine the value on the Z axis corresponding to the current position of the mobile machine and to determine, from amongst the beacon points of the fall back route in the on board database, the beacon points associated with an identifier of the region of the Z axis such that the value on the Z axis determined for the mobile machine is comprised within said region;

said determination module being designed to identify, from among said determined beacon points, the beacon point that is closest to the mobile machine, on the basis of the coordinates of the beacon points in the database and taking into consideration that the determined beacon points are at the same level on the Z axis as the mobile machine; and

said determination module being designed to select a way point to be reached by the mobile machine from among the way points, in the database, which are associated with the same convex zone identifier as the convex zone identifier associated with the beacon point identified.

According to a sixth aspect, the present invention provides a computer programme for fall back from a route designed for a mobile machine and enabling it to reach a fall back route, in a 3D zone of displacement of the mobile machine comprising convex zones each describing a polygon in any plane perpendicular to a Z axis over a region under consideration of the Z axis, said mobile machine storing an on board database of way points and beacon points of a fall back route that has previously been defined by a method according to the first aspect of the invention, said programme including instructions for carrying out the steps of a method according to the fourth aspect of the invention during the execution of the programme by the data processing means.

### BRIEF DESCRIPTION OF THE DRAWINGS

These characteristic features and advantages of the invention will become apparent upon reading the description which follows here below, provided solely by way of example and with reference made to the accompanying drawings, in which:

FIG. 1 is a 3D representation of a zone of displacement of an aerial vehicle comprising convex zones;

FIG. 2 shows a module for defining an emergency route in an embodiment of the invention;

FIG. 3 shows a flow chart of the steps of a method for defining an emergency route in a mode of implementation of the invention;

FIG. 4 shows a view in the plane (X; Y) of the convex zones for an altitude region under consideration;

FIG. 5 shows a 3D zone of displacement of an aerial vehicle comprising convex zones and the beacon points defined for the emergency route;

FIG. 6 shows a fall back module for an emergency route in an embodiment of the invention;

FIG. 7 shows a flowchart of the steps of a fall back method for an emergency route in a mode of implementation of the invention.

### DETAILED DESCRIPTION

Some definitions and properties of the Voronoi diagrams will first of all be recaped.

If one considers a set of points E={x₁, x₂, . . . , xₙ} in a plane, then for each point xᵢ in E, there exists a cell Pxᵢ such that for any x of Pxᵢ, the distance d(x,xᵢ)<d(x,xⱼ), regardless of the value of xⱼ belonging to E (j is different from i). The set of cells Pxᵢ thus defines the Voronoi diagram associated with E. A cell is defined as a polygon that may be open (some of the polygon edges are then straight lines or half lines) or closed (all of the edges are segments).

The principle underlying the invention is to define in each polygon described by a convex zone in a plane, the beacon points associated with the emergency route such that the cells of the Voronoi diagram, which are associated with these beacon points of the polygon, separate this polygon from the other polygons described in the same plane.

Thus, points that belong to different convex zones cannot belong to the same cell of the Voronoi diagram.

In one embodiment, a definition module 1 for defining an emergency route according to the invention designed for an aerial vehicle has a working memory 2, a database 3 meant to be used for storing data for definition of the emergency route, a microprocessor 4 and a human-machine interface 5 comprising for example a monitor, a keyboard and a computer mouse. This module 1 is for example located in a site of base for aerial vehicles.

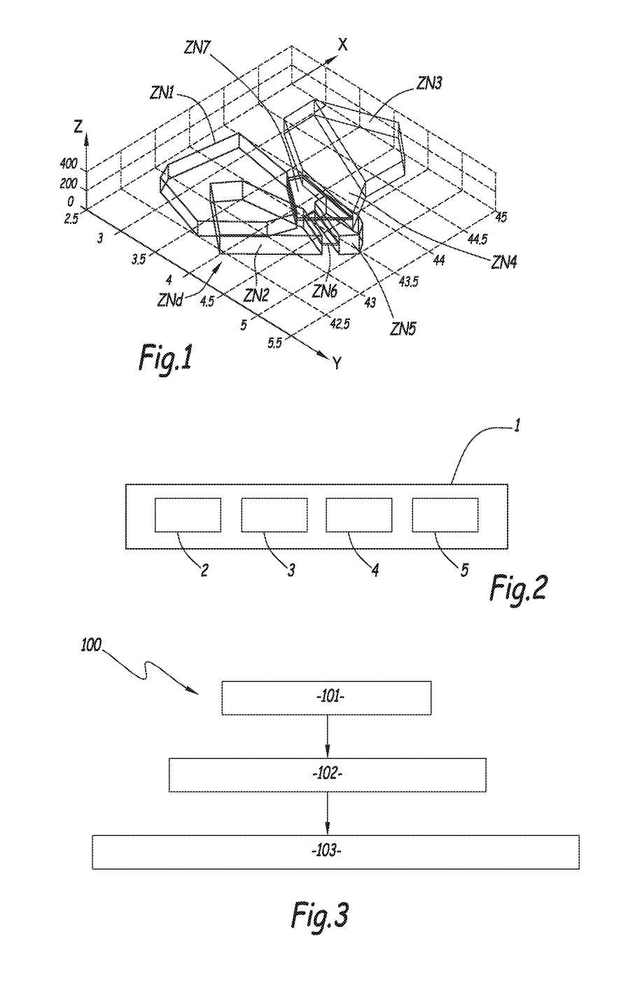

Consider for example the zone of displacement ZNd represented in FIG. 1, having the convex zones ZN1 to ZN7.

In one embodiment of a method 100 for definition of an emergency route according to the invention, with reference to FIG. 2, the steps 101-103 indicated here below are implemented.

In one embodiment, these steps or at least some among them, are carried out following the execution of instructions from a computer software programme, for example, as in the case considered, stored in the memory 2 of the definition module 1.

In the case considered, an ordered sequence of way points Pi, i=1 to m, has been predetermined for the emergency route. The point Pm corresponds for example to the base to which an aerial vehicle should be brought back in an emergency.

An aerial vehicle reaching any whichever way point Pi should then, going from the point Pi, reach the way point Pi+1, and so on, progressing step by step, up to the point Pm.

In the memory 2, the coordinates in a 3D reference point system for each way point are stored. This 3D reference point system, named R, is for example, defined by an origin O and three orthogonal axes X, Y, Z, where Z corresponds to the altitude. The grid 6 is made up of a set of partitions 8 that extend in two directions perpendicular to each other, for example perpendicular and parallel to the vertical diametric plane P of the conduit. The partitions 8 define, in end view (FIG. 1), a plurality of square meshes 9, with side m. Furthermore in the memory 2, each way point is associated with an identifier of the convex zone to which it belongs, which may easily be determined on the basis of the coordinates of the way point and the data for definition of the convex zones. In addition each way point is further associated with an attribute indicating that it is a way point of the emergency route.

The memory 2 of the definition module 1 includes data for definition of the convex zones: it contains in particular, for every zone Zni, i=1 to 7, the floor altitude Zli and the ceiling altitude Zhi of the zone ZNi, and the definition of the sides of the polygon described by zone ZNi in any plane parallel to the plane (X, Y) located at an altitude between the altitudes Zli and Zhi.

In a step 101, the Z axis is cut, starting from the altitude corresponding to the minimum floor altitude among the floor altitudes, and up to the maximum ceiling altitude among the ceiling altitudes, into altitude regions such that within a same given altitude region, the polygons described by the convex zones in this region are described throughout the region. In other words, ordering by ascending order is applied to the altitudes of the set of altitudes consisting of the floor altitudes and ceiling altitudes of the seven zones ZN1 to ZN7. And each altitude region corresponds to a segment between two altitudes of this ordered sequence.

In the case considered, 6 regions of altitude are obtained, namely H1, H2, H3, H4, H5, H6, with:

H1=[Zl2=Zl5; Zl6];

H2=[[Zl6; Zh6];

H3=[Zh6; Zh2=Zh5=Zl4=Zl3=Zl1];

H4=[Zh2=Zh5=Zl4=Zl3=Zl1; Zl7];

H5=[Zl7; Zh7];

H6=[Zh7; Zh4=Zh3=Zh1].

In a step 102, for each altitude region considered successively, beginning with the region H1, a process is carried out in order to construct the points, referred to as beacon points, associated with the emergency route.

Thus the step 102 includes the successive steps 102(1), . . . , 102(6) implemented for the respective altitude regions Hi, with i=1 to 6.

Consider any which plane P1 that is parallel to the plane (X, Y) at any altitude within the region H1: it includes two disjointed polygons described by the convex zones ZN2 and ZN5.

The step 102(1) for the first region of altitudes considered H1 serves the objective of constructing a set of beacon points in the plane P1 such that the edges of the Voronoi diagram in the plane P1 associated with this set are the sides of the polygons described in this plan or separate therebetween the polygons when they do not have common sides.

In this step 102(1), in a first iteration of sub-step 102(1)1, a beacon point PB1 is inserted in the zone ZN2 and a beacon point PB3 is inserted in the zone Zn5 (these points are selected in this present case as the points symmetrical with a point PB2, situated in the space between the polygons described by ZN2, ZN5, relative to the side that is closest to PB2 of each of these polygons).

This insertion is for example defined by the operator of the definition device 1 via the human-machine interface 5, for example by pointing a cursor at a location selected with the use of a mouse on a representation of the plane P1 displayed on the screen and by clicking on a button of the mouse in order to indicate that the beacon point is to be inserted at the location that has been pointed.

Then the additional beacon points that are symmetrical to each of these beacon points inserted into a polygon relative to each of the sides of the polygon are inserted, however, where these symmetrical beacon points are in the zone of displacement ZNd, this is not the case for H1.

The coordinates (X, Y) in the reference point system R of each of these inserted beacon points are stored in the working memory 2, in association with an identifier of the convex zone to which they belong (thus PB1 with the identifier of the zone ZN2 and PB3 with that of the zone ZN5), and in association with a floor altitude equal to the lower limit of altitude for the region H1 (i.e. Zl2=Zl5).

Subsequently, the Voronoi diagram corresponding to the set of beacon points considered is determined. Various different types of known algorithms may be used for this purpose, for example, the algorithm “Quickhull” or the Delaunay triangulation algorithm. The edges of the diagram obtained are compared with the polygons described by the convex zones in the plane P1.

The edges of the Voronoi diagram separate between them the two polygons, while the step 102(1) is terminated. And the process advances to step 102(2).

If for the selected beacon points, the edges of the Voronoi diagram have not separated therebetween the polygons ZN2, ZN5, then in a sub-step 102(1)2, there would been the insertion of one or more new beacon points in one or more polygons described by the convex zones in P1.

For each new beacon point thus inserted into a polygon, there would also have been a further insertion of additional beacon points that are symmetrical with this beacon point relative to the different sides of this polygon in the case where these additional symmetrical beacon points should belong to the zone of displacement ZNd.

The coordinates (X, Y) of each of these beacon points thus inserted would have been stored in the working memory, in association with identifier of the convex zone to which they belong, and in association with a floor altitude equal to the lower limit of altitude for the region H1.

Then it would have been necessary to repeat the sub step 102(1)1 and as necessary the sub step 102(1) until the condition for stopping step 102(1) has been satisfied.

Now consider a region of altitude Hi, for any i between 2 and 6.

The steps 102(1), . . . , 102(i−1) have been implemented for the altitude regions H1, . . . , Hi−1.

If one considers any plane Pi that is parallel to the plane (X, Y) at any altitude in the region Hi: it comprises one or more polygons, each of these polygons is described by a convex zone from among the convex zones ZN1 to ZN7.

The objective of the step 102(i) for the region of altitudes considered Hi is to construct a set of beacon points in the plane Pi such that the edges of the Voronoi diagram in the plane Pi associated with this set separate therebetween the polygons described in this plane, by overlapping the sides that are shared by multiple polygons described in this plane and being intercalated between two sides of two adjacent but unjoined polygons.

All of the beacon points used in the sub step 102 (i−1) are taken into consideration in order to construct the Voronoi diagram corresponding to the polygons described for the region preceding the region Hi.

In the steps relative to Hi consideration is no longer given to the beacon points defined in the preceding step that no longer appear in the zone of displacement ZNd for the current altitude region. For these beacon points, their ceiling altitude is fixed in the memory 2, to a value equal to the lower limit of altitude for the current region.

In a first iteration of the sub step 102(i)1, the Voronoi diagram corresponding to the set of beacon points considered for Hi−1 and situated in the zone of displacement ZNd for the current altitude region, is determined. The edges of the diagram obtained are compared with the polygons described by the convex zones in the plane Pi.

If the edges of the Voronoi polygon separate therebetween the polygons, then the step 102(i) is completed. And the process advances to the step 102(i+1) if i<6.

Otherwise, then in a sub-step 102(i)2, one or more new beacon points are inserted in one or more polygons described by the convex zones in Pi (in total, there must be at least one beacon point per polygon).

As indicated for H1, this insertion is for example defined by the operator of the definition device 1 via the human-machine interface 5, for example, by pointing a cursor at a location selected by using a mouse on a representation of the plane Pi displayed on the screen and by clicking on a button of the mouse to indicate that the beacon point is to be inserted in the pointed place.

For each new beacon point thus inserted into a polygon, there is also a further insertion of additional beacon points that are symmetrical with this beacon point relative to the different sides of this polygon only if they are in the zone of displacement ZNd for the current altitude region.

The coordinates (X, Y) of each of these beacon points thus inserted are stored in the working memory, in association with identifier of the convex zone to which they belong, and in association with a floor altitude equal to the lower limit of altitude for the region of each of these beacon points are inserted and stored in the working memory, in with an belonging to the convex zone, or without zone identifier if they are situated outside the zone displacement of ZNd and in association with a floor altitude equal to the lower limit of altitude for the region Hi.

Then the sub step 102(i)1 and as appropriate the substep 102(i)2 is repeated until the edges of the Voronoi diagram determined separate the polygons.

Once the step 102(6) is completed, the beacon points that have been used for the construction of the Voronoi diagram in the last iteration of the sub step 102(6)1, are associated with the ceiling altitude equal to the upper limit of the region H6 in the temporary memory 2.

In a step 103, each beacon point constructed in the step 102 is stored in the database 3 in association with its coordinates (X, Y), its floor altitude, its ceiling altitude, the identifier of the convex zone to which it belongs as contained in the temporary memory 2, and additionally also in association with an attribute indicating that it is a beacon point of the emergency route.

And the coordinates (X, Y, Z) of each way point stored in the memory 2, are stored in the database 3, in association with an identifier of the convex zone to which it belongs and an attribute indicating that it is a way point of the emergency route.

The data of the emergency route constructed according to the invention, relative to its way points and its beacon points, are thus stored in the database 3.

In one embodiment, in an optional step, one or more beacon points may be additionally added as way points. An attribute is thus added to the database 3 in association with such a beacon point, indicating that it is a way point of the emergency route. Such a beacon point may possibly be added in place of a predetermined way point, which is thus deleted from the database 3, provided that they form part of the same convex zone and for example only if the distance between the beacon point and the way point is less than a given threshold, or even only if the operator of the device 1 has designated them via the human-machine interface module 5.

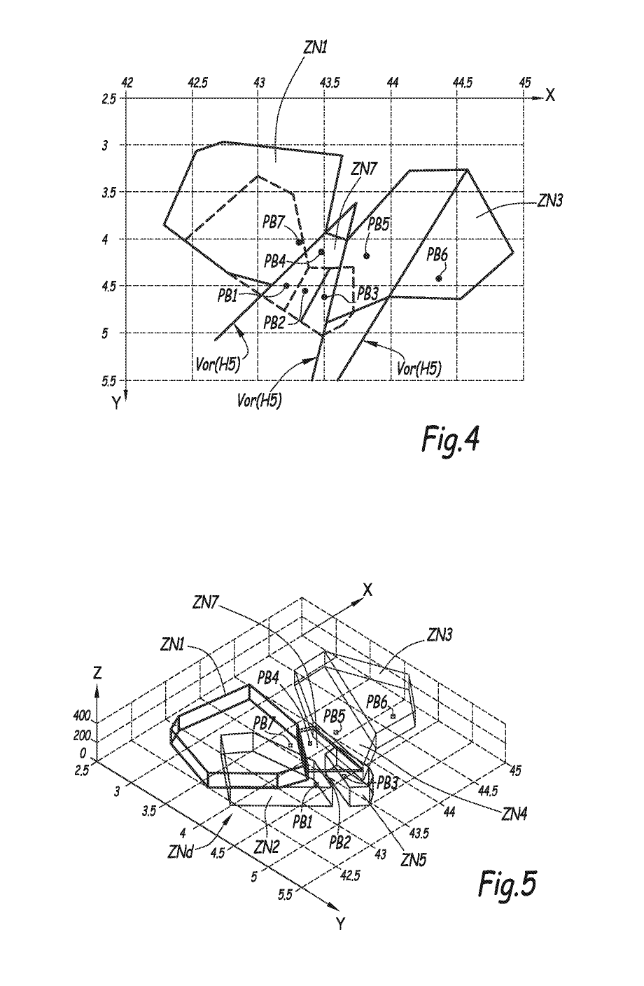

In order to illustrate the preceding steps, FIG. 4 shows the set ZNd_H5 of polygons described by the zone of displacement ZNd in any plane perpendicular to the Z axis, at an altitude included in the region H5. These polygons are four in number and correspond to the convex zones ZN1, ZN3, ZN4 and ZN7. Four beacon points PB3, PB5, PB6, PB7 are required in the step 102(5) for the region H5.

The edges of the Voronoi diagram obtained are indicated by the reference Vor(H5) and overlap the sides of the polygons described by the convex zones ZN1, ZN3, ZN4 and ZN7, thus separating these polygons there between. The other polygons described by the convex zones for at least one other altitude region from among H1, H2, H3, are represented in dotted lines, as well as the beacon points PB1, PB2, PB3 thus used.

For regions of altitude H4 and H6, only PB5 and PB7 shall be used (PB6 is no longer part of the zone ZNd for these altitude regions).

For the region H2, the beacon points PB1, PB2 and PB3 are used.

For the regions H1 and H3, only PB1 and PB3 are used (PB2 is no longer part of the zone ZNd for these altitude regions).

In FIG. 5, the beacon points PB1, PB2, PB3 are shown for the altitude region H2 and the points PB4, PB5, PB6, PB7 are represented for the altitude region H5.

In the case of the altitude region H1, the Voronoi diagram includes an edge which is the bisecting line of the segment [PB1, PB3]. This edge thus figures in the space situated between the polygons described by ZN2 and ZN5 and indeed separates therebetween these polygons.

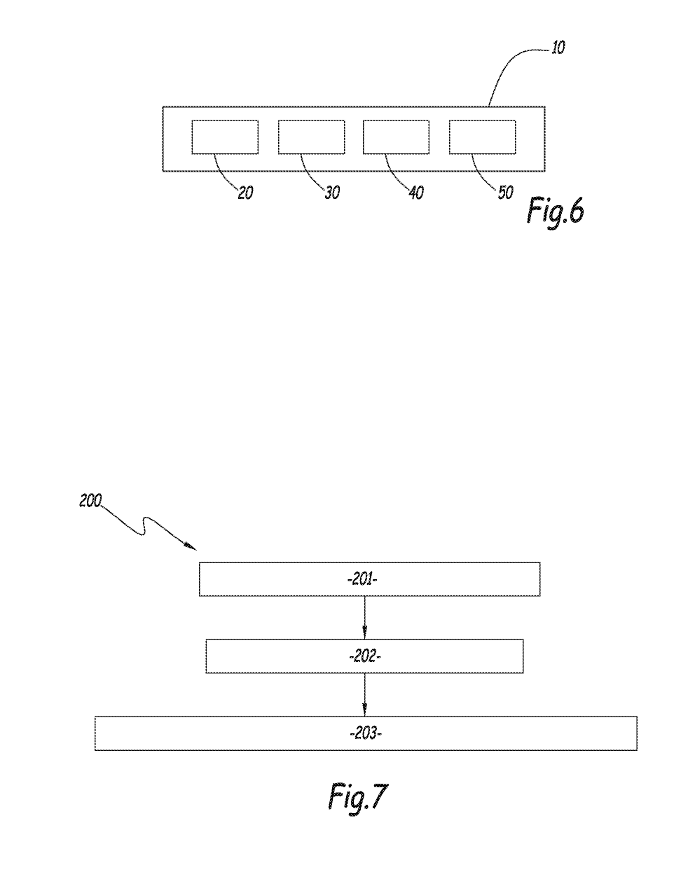

In the described embodiment, the place of insertion of a new beacon point is specified by a user of the device. In another embodiment, it is defined by an algorithm, for example based on constrained optimisation methods, the criterion to be minimised being the number of beacon points being created. In one embodiment, an aerial vehicle includes a fall back module 10 for falling back to an emergency route according to the invention, with reference made to FIG. 6. This fall back module 10 is thus mounted on board the aerial vehicle and includes a working memory 20, a database 30, a microprocessor 40 and a human-machine interface 50 for example comprising a screen and a keyboard.

The aerial vehicle has as permissible zone of displacement the permissible zone of displacement ZNd shown in FIG. 1, including the convex zones ZN1 to ZN7.

It has a flight plan that indicates to it the route to be followed in nominal mode of flight. The flight plan has been designed in a manner such that the aerial vehicle remains in the zone of displacement ZNd. It also includes the means for location indicating its position, which enables it in particular to determine notably its coordinates in the reference point system R.

The aerial vehicle, in one embodiment, does not include the data for definition of the zone ZNd.

On the other hand, the database 30 of the fall back module 10 includes the data for definition of the emergency route as defined here above, which were stored in the database 3, that is to say:

the coordinates (X, Y) of the beacon points in association with their floor altitude, their ceiling altitude, the identifier of the convex zone to which they belong, respectively, and an attribute indicating their beacon point status for the emergency route, and

the coordinates (X, Y, Z) of each way point, in association with an identifier of the convex zone to which it belongs and an attribute indicating their way point status for the emergency route.

Consider that at a moment in time during the nominal flight, the aerial vehicle has to quit its flight plan and reach the emergency route from its current location point, named as C. The fall back operation from point C must imperatively be carried out without departing from the permissible zone ZNd, which is made possible according to the invention by the use of the data pertaining to the emergency route stored in the database 30 by the fall back module.

Thus with reference to FIG. 7, in an embodiment of a method 200 of fall back to an emergency route according to the invention, the steps 201-203 indicated here below are carried out.

In one embodiment, these steps or at least some of them, are carried out following the execution of instructions from a computer software programme, for example in the case under consideration stored in the memory 20 of the fall back module 10.

In a step 201, the beacon points satisfying both of the following two conditions Cond1 and Cond2 are determined:

Cond₁: the floor altitude of the beacon point is lower than the altitude corresponding to the current position of the aerial vehicle; and

Cond₂: the ceiling altitude of the beacon point is higher than the altitude corresponding to the current position of the aerial vehicle.

In a step 202, from among the beacons points determined, the beacon point that is the closest to the current position of the aerial vehicle, is identified. For this, consideration is only given to the coordinates of the beacon points and point C for locating of the aerial vehicle in the plane (X, Y) of the reference point system R (in other words, they are considered at the same altitude).

In a step 203, once the closest beacon point has been identified, a way point is selected, in the database 30, from among the way points which are associated with a convex zone identifier that is identical to the convex zone identifier associated in the database 30, with the beacon point thus identified.

The selection may be made based on various distinct criteria. The selection criterion may be to choose the way point that is the closest to the point C in R, or the point that minimises the distance travelled on the emergency route.

The aerial vehicle then going from its current point C, reaches the selected way point.

This current point C and the beacon point identified are necessarily in the same convex zone, on account of the properties of the Voronoi diagrams, and due to the fact that the edges of the Voronoi diagram of the beacon points defined for the altitude region considered coincide with the sides of the polygons described by the permissible zone ZNd over the altitude region considered (in fact, if one were to consider a set of points E={xi/i=1 à n} in a plane, then for each point xi in E, its Voronoi cell Pxi in the plane is such that for any x within Pxi, the distance d(x,xi)<d(x,xj), regardless of the value of xj belonging to E (j is different from i).

Therefore the selected way point, which forms part of the same convex zone as the identified beacon point, and the currant point C, both form part of the same convex zone. The aerial vehicle will therefore not depart from the permissible zone in reaching the way point from the point C.

The invention thus enables the fall back to the emergency route without leaving the permissible zone, while also avoiding the storage in the aerial vehicle of the data for definition of the permissible zone. The volume of calculations to be performed is thus limited.

For illustration purposes, in the example under consideration, only seven beacon points were necessary, while the known approach of the state of the art requires the knowledge of 35 vertices of the convex zones ZN1 to ZN7.

In the embodiment described, the regions were processed in increasing order of altitude.

In another embodiment, they are processed in decreasing order of the number of polygons described by the convex zones within the regions, which is advantageous for an optimal choice in the total number of beacon points necessary for the zone of displacement.

In one embodiment, the coordinate on the Z axis of the way points is replaced by an indication of an altitude region.

In the embodiment described with reference made to the drawings, the Z axis along which the convex zones describe constant polygons over the regions of the Z axis corresponds to the axis of altitude.

In the description here above, the mobile machine considered was an aerial vehicle. Quite obviously, the invention may be implemented for any type of mobile machine, for example a submarine, a car etc.

1. A method for defining a fall back route comprising of way points, for a mobile machine, in a 3D zone (ZNd) of displacement having convex zones (Zni, i=1 to 7) such that over a considered region (Hj, j=1 to 6) of a Z axis, said zones each describe a polygon in any plane perpendicular to a Z axis, said method being characterised in that it is implemented on a computer and in that it comprises the following steps i/ to ii/ relative to said region of the Z axis, in considering any plane perpendicular to the Z axis over said region:
i/ defining a set of points (PBk, k=1 to 7), referred to as beacons points for the fall back route, such that the edges of the Voronoi diagram associated with said set of beacon points separate therebetween the polygons described by the convex zones in said plane; and
ii/ in a database, associating with each way point of the fall back route and each beacon point of the route, an identifier of the convex zone to which said point belongs, coordinates of said point and for each beacon point, an identifier of the said region of the Z axis.

2. A method for defining a fall back route according to claim 1, in which the way points of the fall back route include at least some of said beacon points in said region under consideration (Hj, j=1 to 6) of the Z axis.

3. A method for defining a fall back route according to claim 1, in which:
the Z-axis is cut into a plurality of regions (Hj, j=1 to 6), such that the polygons described by the convex zones of the zone of displacement are constant in all planes perpendicular to the Z axis over a same region;
in each region, the steps i/ and ii/ are carried out.

4. A method for defining a fall back route according to claim 1, in which in step i/, a new beacon point is inserted in a polygon described in a convex zone (Zni, i=1 to 7), and moreover there is a further addition of every additional beacon point that is symmetrical with said new beacon point relative to any side of said polygon and which is located in another polygon, described by another convex zone over said region of the Z axis (Hj, j=1 to 6).

5. A module for defining a fall back route comprising of way points, for a mobile machine, in a 3D zone (ZNd) of displacement having convex zones (ZNi, i=1 to 7) such that over a considered region (Hj, j=1 to 6) of a Z axis, said zones each describing a polygon in any plane perpendicular to a Z axis,
said module being characterised in that it is adapted to, relative to said region of the Z axis and taking into consideration any plane perpendicular to the Z axis over said region, define a set of points (PBk, k=1 to 7), referred to as beacon points, for the fall back route, such that the edges of the Voronoi diagram associated with the said set of beacon points separate therebetween the polygons described by convex zones in said plane; and
in that it is adapted so as to, in a database, associate with each way point of the fall back route and each beacon point of the route, an identifier of the convex zone to which said point belongs, coordinates of the said point and for each beacon point, an identifier of the said region of the Z axis.

6. A computer programme for defining a fall back route comprising of way points, for a mobile machine, in a 3D zone (ZNd) of displacement having convex zones (ZNi, i=1 to 7) such that over a considered region (Hj, j=1 to 6) of a Z axis, said zones each describe a polygon in any plane perpendicular to a Z axis, said programme including instructions for carrying out the steps of a method according to claim 1 during the execution of the programme by data processing means.

7. A method of fall back, by a mobile machine, to a fall back route, in a 3D zone (ZNd) of displacement of the mobile machine having convex zones each describing a polygon in any plane perpendicular to a Z axis in a region under consideration (Hj, j=1 to 6) of the Z axis, said method being characterised in that:
the mobile machine stores an on board database of way points and beacon points (PBk, k=1 to 7) of a fall back route that has been previously defined by a method according to claim 1; and
in that said method comprises of the following steps of:
determination of the value on the Z axis corresponding to the current position of the mobile machine and determination, from among the beacon points of the fall back route in the on board database, of the beacon points associated with an identifier of the region of the Z axis such that the value on the Z axis determined for the mobile machine is comprised within said region;
identification, from among said beacon points determined, of the beacon point that is closest to the mobile machine, on the basis of the coordinates of the beacon points in the database and taking into consideration that the determined beacon points are at the same level on the Z axis as the mobile machine; and
selection of a way point to be reached by the mobile machine from among the way points, in the database, which are associated with the same convex zone identifier as the convex zone identifier associated with the beacon point identified.

8. A module for determination for a mobile machine of a fall back route, in a 3D zone (ZNd) of displacement of the mobile machine comprising convex zones each describing a polygon in any plane perpendicular to a Z axis over a region under consideration (Hj, j=1 to 6) of the Z axis;
the mobile machine storing an on board database) of way points and beacon points (PBk, k=1 to 7) of a fall back route that has previously been defined by a method (100) according to claim 1;
said determination module being designed to determine the value on the Z axis corresponding to the current position of the mobile machine and to determine, from amongst the beacon points of the fall back route in the on board database, the beacon points associated with an identifier of the region of the Z axis such that the value on the Z axis determined for the mobile machine is comprised within said region;
said determination module being adapted to identify, from among said determined beacon points, the beacon point that is closest to the mobile machine, on the basis of the coordinates of the beacon points in the database and taking into consideration that the determined beacon points are at the same level on the Z axis as the mobile machine; and
said determination module being adapted to select a way point to be reached by the mobile machine from among the way points, in the database, which are associated with the same convex zone identifier as the convex zone identifier associated with the beacon point identified.
